(19) United States
(12) Patent Application Publication
(10) Pub. No.: US 2012/0117136 A1
(43) Pub. Date: May 10, 2012

(54) Data verification algorithm for RF receivers

(76) Inventor: Toshio Hayakawa, Los Angeles, CA (US)

(21) Appl. No.: 12/939,911

(22) Filed: Nov. 4, 2010

(51) Int. Cl. G06F 7/487; G06F 7/485

(52) U.S. Cl. 708/623

(57) ABSTRACT

Sending a set of two data, having actual data and calculated data by using the actual data, to a communication device using RF signal works as a virtual check sum function.

### BACKGROUND

1. Field of Invention

This patent relates to a data verification algorithm for communication devices using RF signal.

2. Description of Prior Art

Since RF receivers, such as AM/FM radio receivers or inexpensive electronic price label (EPL) display devices, luck a method to verify data, this patent provides a data verification algorithm for mono-directional communication devices.

### OBJECTIVES AND ADVANTAGES

This patent can substitute elaborative and expensive bi-directional communication method with single communication method so that very low cost information display devices can be manufactured easily. Also, the infrastructure cost for bi-directional communication devices can be reduced significantly since data acknowledgement or handshake is not necessary. Furthermore, since devices do not need to transmit acknowledge return signal for handshaking, the power consumption of mono-directional communication devices is much less than conventional bi-directional communication devices that use RF signal.

### SUMMARY

Conventional communication devices using RF signal use expensive bi-directional communication methods to verify sent data by calculating the data received and compared the data against check sum data sent along with the data in a receiver. If the calculated data in the receiver does not match, then the receiver requests a transmitter to re-send the data again. This process repeats until the receiver receives the correct data. However, data display devices such as EPL requires very low cost because tens of thousands of them would have to be installed in a typical grocery store where current method uses paper price tags. Hence, the cost of EPL must be very low. This patent enables manufacturers to manufacture such low cost display devices by replacing bi-directional communication method with mono-directional communication method.

### OPERATION

To verify a data received in mono-directional communication device is to send a set of two data from a transmitter. The first data is a real data, such as a price information data, divided by 10 and the second data, which is calculated by subtracting the first data from constant number 1, where the first data is in between 0 to 10 decimal.

In real operation, a RF receiver or a bi-directional communication device should have a constant number 1 built-in in the memory. The device adds the first data and the second data then compares the sum against the built-in constant number 1. If both numbers matches then the set of two data is sent without loss in mono-directional transmission. If it does not match then there is loss of data. The transmitter sends the set of data continuously until the sum matches with the constant number 1 in the device.

### CONCLUSION, RAMIFICATIONS, AND SCOPE

Using this algorithm, communication device manufacturers can produce very low cost RF devices with accurate data transmission using mono-directional transmission method. Also, many of current bi-directional communication devices can implement this algorithm to reduce the cost of devices. The scope of this invention covers all communication devices where bi-directional communication method is used.

I claim:

1. Data sent by RF signal comprising:
(a) a set of two data,
wherein the first data is data divided by 10 and the second data is calculated by subtracting the first data from a constant number 1, where the first data is in between 0 to 10 decimal.
